(19) United States
(12) Patent Application Publication
(10) Pub. No.: US 2023/0029072 A1
(43) Pub. Date: Jan. 26, 2023

(54) SYSTEMS AND METHODS FOR SUBSURFACE FORMATION MODELLING

(71) Applicant: COMMONWEALTH SCIENTIFIC AND INDUSTRIAL RESEARCH ORGANISATION, Acton, Australian Capital Territory (AU)

(72) Inventors: James GUNNING, Acton (AU); Roman BELOBORODOV, Acton (AU); Irina EMELYANOVA, Acton (AU); Marina PERVUKHINA, Acton (AU); Michael CLENNELL, Acton (AU); Juerg HAUSER, Acton (AU)

(73) Assignee: COMMONWEALTH SCIENTIFIC AND INDUSTRIAL RESEARCH ORGANISATION, Acton, Australian Capital Territory (AU)

(21) Appl. No.: 17/784,150

(22) PCT Filed: Dec. 18, 2020
(86) PCT No.: PCT/AU2020/051392

§ 371 Date: Jun. 10, 2022

(30) Foreign Application Priority Data
Dec. 30, 2019 (AU) 2019904963

(51) Int. Cl. G01V 1/50; G01V 11/00

(52) U.S. Cl. CPC G01V 1/50; G01V 11/00; G01V 2210/626; G01V 2210/624

(57) ABSTRACT

Described embodiments generally relate to a computer-implemented method for modelling a subsurface formation. The method comprises receiving measurement data related to the subsurface formation, the measurement data comprising a plurality of data points; determining at least one rock physics model, each rock physics model relating to a rock type; assigning each data point of the measurement data to at least one initial rock class membership; fitting each determined rock physics model of the at least one rock physics model to the data points of the measurement data to produce at least one fitted rock physics model; reassigning each data point to at least one rock class based on the fitted rock physics models; determining whether a convergence criterion has been met; and responsive to the convergence criterion not being met, repeating the fitting and reassigning steps.

### TECHNICAL FIELD

Embodiments generally relate to systems and methods for modelling subsurface formations. In particular, embodiments relate to systems and methods for modelling subsurface formations using rock physics models.

### BACKGROUND

It is often desirable to understand the properties of subsurface formations, and the likelihood of the presence of certain rocks, minerals, oils and gases in these formations. Existing methods for determining the properties of subsurface formations include using a variety of sensor types to measure data relating to the formation, and to use the data to determine the formation properties. However, manually analysing subsurface formation measurement data is time consuming, and can lead to inaccuracies.

It is desired to address or ameliorate one or more shortcomings or disadvantages associated with prior systems and methods for modelling subsurface formations, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer-implemented method for modelling a subsurface formation, the method comprising:
receiving measurement data related to the subsurface formation, the measurement data comprising a plurality of data points;
determining at least one rock physics model, each rock physics model relating to a rock type;
assigning each data point of the measurement data to at least one initial rock class membership;
fitting each determined rock physics model of the at least one rock physics model to the data points of the measurement data to produce at least one fitted rock physics model;
reassigning each data point to at least one rock class based on the fitted rock physics models;
determining whether a convergence criterion has been met; and
responsive to the convergence criterion not being met, repeating the fitting and reassigning steps.

Some embodiments further comprise, based on the convergence criterion being met, outputting at least one fitted one rock physics model that models at least a portion of the subsurface formation.

Some embodiments further comprise determining at least one property of the subsurface formation based on the at least one output rock physics model.

Some embodiments relate to a method of performing an operation on a subsurface formation, the method comprising the method of some other embodiments, and further comprising performing the operation based on the output data.

Some embodiments further comprise pre-processing the measurement data to improve the quality of the measurement data.

According to some embodiments, improving the quality of the measurement data comprises identifying and discarding invalid measurement data.

In some embodiments, improving the quality of the measurement data comprises receiving information from tool indicators within the subsurface formation and correcting the measurement data according to the information received.

In some embodiments, assigning each data point of the measurement data to at least one initial rock class membership comprises randomly assigning each data point of the measurement data to at least one initial rock class membership.

In some embodiments, assigning each data point of the measurement data to at least one initial rock class membership comprises using an automatic clustering method.

According to some embodiments, fitting each determined rock physics model to the data points comprises performing parameter estimation for each rock type and weighing each rock type by the rock class memberships.

In some embodiments, fitting each determined rock physics model to the data points comprises identifying a best fitting rock physics model for each data point using an optimisation algorithm.

According to some embodiments, reassigning each data point to at least one rock class based on the fitted rock physics models comprises comparing at least one parameter for the subsurface formation determined by each fitted rock physics model with at least one measured parameter determined from the received measurement data.

According to some embodiments, reassigning each data point to at least one rock class based on the fitted rock physics models comprises assessing a goodness of fit between each fitted rock physics model and each data point.

In some embodiments, fitting each determined rock physics model to the data points of the measurement data comprises jointly minimising the misfits for more than one set of physical properties of the subsurface formation.

In some embodiments, fitting each determined rock physics model to the data points of the measurement data comprises severally minimising the misfits for more than one set of physical properties of the subsurface formation.

According to some embodiments, the more than one set of physical properties include the elastic properties of the subsurface formation and the electrical properties of the subsurface formation. In some embodiments, the more than one set of physical properties include the elastic properties of the subsurface formation and the electromagnetic properties of the subsurface formation.

According to some embodiments, determining at least one rock physics model comprises receiving the at least one rock physics model from a remote database.

In some embodiments, determining whether a convergence criterion has been met comprises determining whether a threshold number of iterations of the method have been performed.

According to some embodiments, determining whether a convergence criterion has been met comprises determining whether a change in a likelihood that the data points belong to the fitted rock physics models is below a predetermined threshold.

Some embodiments further comprise rejecting rock physics models that do not fit the physical bounds of the measurement data.

In some embodiments, each rock physics model defines a relationship between at least one physical rock property and a rock burial depth for a particular rock type.

In some embodiments, the measurement data is received from at least one wellbore. In some embodiments, the measurement data is received from a core or cutting of the subsurface formation.

Some embodiments relate to a system for modelling a subsurface formation, the system comprising:
memory storing program code;
a processor configured to access the program code;
wherein, when executing the program code, the processor is caused to:
receive measurement data related to the subsurface formation, the measurement data comprising a plurality of data points;
receive at least one rock physics model;
assign each data point of the measurement data to at least one initial rock class membership;
fit each received rock physics model to the data points;
reassign each data point to at least one rock class based on the fitted rock physics models;
determine whether a convergence criterion has been met; and
responsive to the convergence criterion not being met, repeating the fitting an reassigning steps.

### BRIEF DESCRIPTION OF DRAWINGS

Embodiments are described in further detail below, by way of example and with reference to the accompanying drawings, in which:

FIG. 1 shows a block diagram of a subsurface formation modelling system according to some embodiments;

FIG. 2 shows a flowchart illustrating a method of subsurface formation modelling, as performed by the system of FIG. 1 according to some embodiments;

FIG. 3 shows an example graph showing subsurface formation data being fit to two rock physics models according to the method of FIG. 2; and

FIG. 4 shows an example graph showing subsurface formation data being characterised into rock types according to the method of FIG. 2.

### DETAILED DESCRIPTION

Embodiments generally relate to systems and methods for modelling subsurface formations. In particular, embodiments relate to systems and methods for modelling subsurface formations using rock physics models.

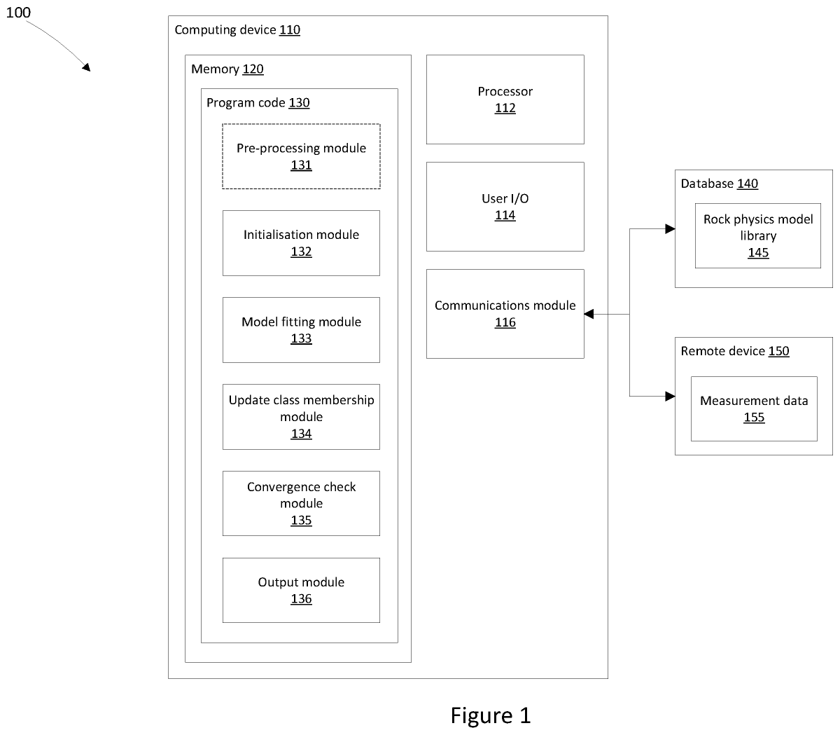

FIG. 1 shows a block diagram of a subsurface formation modelling system 100 for modelling subsurface formations using rock physics models according to some embodiments. Rock physics models may be empirical or theoretical models that relate one set of physical rock properties to another independent rock property, such as depth or temperature. Rock physics models may relate one set of properties to another via a range of fitting parameters, which may have physical meaning in some embodiments. For example, fitting parameters may include a silt-to clay ratio, a percentage of cement in the rock, or the stiffness moduli of mineral components.

System 100 is configured to use measurements and/or data from one or more wells to perform rock typing, and to determine a suitable or matching set of rock physics models for at least one identified subsurface formation. Specifically, system 100 may be configured to use measurements of physical rock properties to fit rock physics models to the measured data, then compute the predicted physical properties of the rock types associated with the rock physics models, and compare these with measured physical properties to assess the appropriateness of the model. The physical properties may include elastic, electrical, electromagnetic and mechanical properties in some embodiments. System 100 may employ an iterative method to then determine the best fitting rock physics model for each data point of the measurements.

System 100 comprises a computing device 110. Computing device 110 may comprise one or more computers, servers, or other computing devices, and may be a distributed server system or a cloud based computing system in some embodiments.

Computing device 110 includes memory 120, storing program code 130. Memory 120 may comprise one or more volatile or non-volatile memory types, such as RAM, ROM, EEPROM, or flash, for example. Computing device 110 further comprises a processor 112, which may comprise one or more microprocessors, central processing units (CPUs), application specific instruction set processors (ASIPs), or other processors capable of reading and executing instruction code. Processor 112 may be configured to access memory 120, and to execute instructions stored in program code 130.

Computing device 110 further includes user I/O 114, which may include one or more forms of user input and/or output devices, such as one or more of a screen, keyboard, mouse, touch screen, microphone, speaker, camera, or other device that allows information to be delivered to or received from a user. Computing device 110 may also include communications module 116. Communications module 116 may be configured to communicate with one or more external computing devices or computing systems, via a wired or wireless communication protocol. For example, communications module 116 may facilitate communication via at least one of WiFi, Bluetooth, Ethernet, USB, or via a cellular network in some embodiments.

In the illustrated embodiment, communications module 116 is in communication with a database 140 and a remote device 150. Database 140 contains rock physics model library 145. Rock physics model library 145 may comprise a library of rock physics models, which may be theoretical rock physics models, and/or empirical rock physics models compiled based on previously measured well data.

Some rock physics models stored in rock physics model library 145 may define a relationship for at least one of the physical properties, their transformations, or combinations, to a rock burial depth for a particular rock facies, rock type, or rock class. These physical properties may include elastic rock properties, such as compressional wave or P-wave velocity V_{P}, shear wave or S-wave velocity V_{S}, density, attenuation, electrical properties such as resistivity or dielectric permittivity, magnetic properties such as magnetic susceptibility, mechanical properties, such as compressibility or hardness or other properties. Transformations or combinations of rock properties may include V_{P} to V_{S} ratio, compressional wave slowness 1/V_{P}, or logarithm of resistivity. For example, rock types may include shale, sandstone, limestone, gas bearing sandstone, coal, and other rock types. According to some embodiments, rock types may include formations, which may be a mixture of two or more rock types, such as a shale formation, for example. As the product of velocity and density is acoustic impedance or elastic response, rock physics models can be used to identify rock types based on seismic reflections, which are related to the acoustic impedance of specific rock types.

According to some embodiments, rock physics models stored in rock physics model library 145 may jointly define more than one physical property for a particular class, facies, or type of rock, such as jointly predicting some combination of electrical, magnetic, dielectric, mechanical, and elastic properties. Some rock physics models stored in rock physics model library 145 may define a relationship for a mixture of rock types, such as thinly layered formations or formations in which inclusions or patches of one type of rock are distributed within another type of rock. Some rock physics models stored in rock physics model library 145 may be formulated to account for anisotropy in the physical properties of the rock formation when measured in different directions, and may be used to quantify the level of anisotropy through coefficients that express the contrast in physical properties in different directions. Some rock physics models stored in rock physics model library 145 may be formulated to relate a plurality of measured physical properties, including some combination of elastic, mechanical, electrical, magnetic and dielectric properties to changes in desired characteristics of the subsurface formation, for example, such as degree of cementation, content of clay minerals, content of organic matter, porosity, permeability and type and content of fluids present in the pores of the rock, such as water, gas and hydrocarbon fluids. A plurality of rock physics models stored in rock physics model library 145 may be used, severally, to define a set of relationships between a plurality of measured physical properties of the subsurface formation and one or more desired characteristics of the subsurface formation. According to some embodiments, rock physics models that define elastic properties of a formation may be used in combination with rock physics models that define electrical, dielectric or magnetic, properties of the formation.

Rock physics model library 145 may also include parameters such as grain size and mineralogy relevant to each rock type, as well as the relationship between the parameters and the content of fluids such as water, oil or gas within the pores of the rock. Each model may predict a level of change in the set of physical properties, such as V_{P}, V_{S}, density, hardness, and electrical, magnetic and dielectric properties, of any given rock saturated with arbitrary fluid with a change in depth and/or compaction. Rock physics models stored in rock physics model library 145 may be theoretical, or empirical. According to some embodiments, rock physics models stored in rock physics model library 145 may comprise existing published data sourced from texts such as publications and books, such as Mavko, G., Mukerji, T., & Dvorkin, J. (2009). The Rock Physics Handbook: Tools for Seismic Analysis of Porous Media. Cambridge: Cambridge University Press. doi:10.1017/CBO9780511626753, and Schön, J. H. (2011), Physical Properties of Rocks: Handbook of Petroleum Exploration and Production, Vol. 8. Elsevier, 494 pp. ISBN: 9780444537966.

According to some embodiments, rock physics model library 145 may comprise new models specifically developed or measured for a particular rock type. According to some embodiments, new rock physics models may be developed for a particular geological formation that consists of more than one rock type mixed at a fine scale, for example sandstone and shale alternating in thin layers, such that the measurements made at a larger scale in wells passing through that formation assume effective property values rather than assuming singular values for the individual rock types comprising the formation.

When rock physics models are theoretically developed, having a number of physically meaningful parameters for each rock type, the model outputs may be used to directly infer the physical and mechanical properties of the formations, such as mineralogy, texture, grain size, porosity, degree of cementation, content of water and hydrocarbon fluids, for example. When the rock physics models are empirically derived, they may fit the measurement data successfully, and give a positive indication of the rock type, such as sandstone, shale, or limestone, or indicate the characteristics of a geological formation that consists of a mixture of more than one rock type, such as an alternation of thin layers of sandstone and shale. Rock physics models, whether theoretically or empirically derived, may not fit all geological formations owing to mixing, resolution and the heterogeneous nature or rock.

Remote device 150 comprises measurement data 155. According to some embodiments, measurement data 155 may comprise a plurality of data points, each data point containing data obtained from measurement of at least one location within a subsurface formation. Measurement data 155 may include data from petrophysical well logs, which are recorded signals from petrophysical tools used in the wellbore, such as measurements of natural radioactivity, lithodensity from gamma ray absorption, photoelectric factor from Compton scattering, neutron adsorption, electrical, dielectric and magnetic properties, and the travel time of elastic waves. Measurement data 155 may also include data collected on samples recovered from the subsurface such as drill cuttings, drill cores or sidewall cores, and include measurements of sample mineralogy and physical properties. Measurement data 155 may further include geological observations of said samples recovered from cores and cuttings to determine directly the type of rock based on appearance, microscopic structure and texture. Measurement data 155 may further include data collected by scanning recovered cores and rock samples using means such as x-radiography, x-ray tomography, x-ray fluorescence, or infrared. For example, measurement data 155 may comprise downhole petrophysical measurements obtained from one or more wells. According to some embodiments, measurement data 155 may comprise well logging data obtained by well logging tools. For example, measurement data 155 may comprise one or more of gamma ray data, neutron porosity data, resistivity data, density data and seismic velocity data, such as compressional wave or P-wave velocity V_{P}, and shear wave or S-wave velocity V_{S}. Measurement data 155 may comprise a multi-dimensional data set, containing data relating to more than one property for each data point. In some embodiments, remote device 150 may comprise one or more well logging tools. According to some alternative embodiments, remote device 150 may be configured to communicate with one or more well logging tools, to receive and compile well logging data generated by the well logging tools, and to store the data as measurement data 155. In some embodiments, remote device 150 may be configured to communicate with laboratory rigs to receive and store physical data obtained on cored rocks extracted from boreholes.

Referring again to computing device 110, program code 130 of memory 120 may comprise a plurality of code modules executable by processor 112 to cause computing device 110 to use measurement data 155 for a particular subsurface formation received from remote device 150 via communications module 116 to determine a matching set of rock physics models from rock physics model library 145 received from database 140 via communications module 116. This may allow for the properties of the subsurface formation, such as the probability of particular rocks, minerals, oils or gases existing in the formation, to be determined. It may further allow for mechanical properties of the formation, such as hardness, brittleness, levels of compaction, texture and fluid content, to be determined. Knowing the properties of the subsurface formation may allow for a risk assessment to be undertaken prior to any operations on the subsurface formation, such as drilling, to prevent hazards such as overpressure, gas pockets, or the occurrence of swelling clays. Furthermore, knowing the properties of the subsurface formation may allow for future wells to be positioned in locations in which there is a high probability of finding a desirable resource. Analysing subsurface formation properties may also assist in improving resource recovery from existing wells, better managing subsurface resources, avoiding risks from geomechanical events, exploiting geothermal resources, and assisting in geological storage of CO₂, natural gas, hydrogen, or other resources.

Specifically, program code 130 may include an initialisation module 132, a model fitting module 133, an update class membership module 134, a convergence check module 135, and an output module 136. According to some embodiments, program code 130 may also include optional pre-processing module 131.

When executed by processor 112, pre-processing module 131 may be configured to receive measurement data 155 via communications module 116, and to apply at least one form of pre-processing to the data. For example, pre-processing module 131 may be configured to check the quality of measurement data 155. Checking the quality of the data may include assessing the validity and accuracy of measurements, checking the accuracy of the position and value of the readings, and checking indicators of tool functioning. Checking the quality of the data may also comprise using further measurements specifically collected to determine the environment surrounding the tool making the measurement. These further measurements can indicate that the petrophysical tool or other measurement system used in the borehole or to measure retrieved subsurface samples is operating within its specifications. Quality control measures may also include measurement of the borehole diameter using a mechanical, ultrasonic or electrical calliper to detect any deviation from an expected gauge of the borehole. When the borehole size is too large or irregular, then invalid measurements may be discarded. According to some embodiments, pre-processing module 131 may be configured to correct the measurement data 155, by making amendments to the data according to information from the tool indicators and information concerning the tool surroundings, such as borehole temperature, borehole diameter and borehole fluid chemical composition, such that the measurements more correctly represent the true condition and characteristics of the rock. Pre-processing module 131 may further be configured to perform depth shifting or environmental correction, in some embodiments.

Pre-processing module 131 may further be configured to remove other noise, errors and outliers from measurement data 155. Further forms of pre-processing may involve the removal or correction of instrumental errors such as skipped cycles or distortions in signal amplification, correction for the changing conditions of temperature, pressure and chemical composition in the wellbore. Further forms of pre-processing may involve reconstruction of missing data based on any theoretical or empirical relations or derived using some kind of gap filling approaches. Further forms of pre-processing may involve the averaging or smoothing of the measured data, so that different physical property measurements have the same length scale of support, which may be around 15 cm or 30 cm in some embodiments. Further forms of pre-processing may involve the deriving of new input data from the original measured data of one or several types using existing theoretical or empirical relations, including but not limited to derivation of porosity from density or nuclear magnetic response (NMR) measurements.

When executed by processor 112, initialisation module 132 may be configured to perform cluster analysis on measurement data 155, which has optionally been pre-processed by optional pre-processing module 131. Specifically, initialisation module 132 may be configured to assign each measurement point an initial class membership. The initial class membership for each point of measurement data may be defined randomly, via a partitioning method, hierarchical clustering, fuzzy clustering, density based clustering, distance based clustering or model based clustering. For each depth for which there exists measurement data 155, initialisation module 132 may perform cluster analysis by selecting a number of rock types and fluid contents that are anticipated to occur in the subsurface formation being analysed, and assigning memberships for each data point of measurement data 155 to each selected rock type, where memberships are the probabilities for each data point that at a given depth, the data point is attributed to the predefined rock type. In some embodiments, rock types that are anticipated to occur in the formation may be pre-selected by a human operator. In some embodiments, all known rock types may be analysed initially, with any rock types that do not fit the physical bounds of the data being rejected.

According to some embodiments, initialisation module 132 may also use a training or calibration step to assist in assigning memberships to data points. To understand the measured data and facilitate the convergence of the algorithm by choosing a reasonable initial guess, some embodiments of the initialisation module 132 may involve automatic clustering methods including but not limited to t-Distributed Stochastic Neighbour Embedding (t-SNE), k-means, Hierarchical Agglomerative Clustering (HAC), and Hierarchical Density-Based Spatial Clustering (HDBSCAN).

Each data point may be attributed to more than one rock type, with each rock type having a separate and distinct probability of membership for that data point. According to some embodiments, some data points may also be assigned memberships to an “unclassified” rock type, corresponding to a rock type which is not expected in the subsurface formation being analysed. According to some embodiments, the memberships may be assigned randomly during an initial clustering step performed by initialisation module 132, and may be automatically adjusted in further iterations by update class membership module 134. According to some embodiments, initialisation module 132 may use a different statistical algorithm to perform initial clustering. According to some embodiments, initialisation module 132 may use various machine learning algorithms to perform clustering.

Update class membership module 134 may identify latent variables that describe the membership of the clusters to adjust the cluster distributions. The iterative process allows update class membership module 134 to improve the clustering step, learning from the data to reduce misfits and to enable patterns of coherent depth trends to be identified, as explained in further detail below. For example, the way each cluster is defined may be adjusted, including the cluster's mean and covariance. The overall shape of each cluster, and the locus of the mean values of the parameters in the fitted model may be used to determine the trends in the rock data for any given depth.

According to some embodiments, model fitting module 133 and update class memberships module 134 may be configured to find for each rock class the probability for a fitted instance of the rock physics model from the rock physics library 145 to be representative of that class. Modules 133 and 134 may be configured to do this using one or more of an Expectation Maximisation algorithm, Markov chain Monte Carlo method, or other method.

When executed by processor 112, model fitting module 133 may be configured to receive the processed measurement data from initialisation module 132, and to retrieve or receive rock physics models from rock physics library 145 via communications module 116, to fit a rock physics model to the measurement data. According to some embodiments, model fitting module 133 may be configured to fit a single rock physics model to the measurement data that jointly predicts a plurality of physical properties of a subsurface formation. According to some embodiments, a single model retrieved from the rock physics library 145 will be configured to predict elastic properties, and simultaneously to predict electrical properties, dielectric properties or magnetic properties. According to some embodiments, model fitting module 133 may be configured to fit a plurality of measurement data, such that these models, severally, predict a plurality of physical properties of a subsurface formation. According to some embodiments, a first model retrieved from the rock physics library 145 will be configured to predict elastic properties and a further model retrieved from the rock physics library 145 will be configured to predict electrical, dielectric or magnetic properties. According to some embodiments, only rock physics model library 145 for rock types that are anticipated to occur in the subsurface formation being analysed may be retrieved from database 140. Model fitting module 133 may further be configured to perform parameter estimation on each rock type that is anticipated to occur in the subsurface formation being analysed, by weighting each rock type by the memberships of the clustered data received from update class memberships module 134 or, in the first iteration, from initialisation module 132.

Performing model selection and its parameter estimation for each rock type may comprise identifying a best fitting model from rock physics model library 145 by fitting one or more physically plausible depth trends of physical properties as defined by this rock physics model to the data weighted by memberships using an optimisation algorithm. The optimisation algorithm may be a bound-constrained optimisation algorithm for fitting non-linear models, such as trust-region or simplex method algorithms. The physical properties may include at least one of V_{P}, V_{S}, resistivity, neutron porosity or density, and may be selected depending on the rock type and depth. Performing parameter estimation for the physical properties that do not exhibit depth trends may further comprise estimating a mean value, quantifying a depth independent relationship between all of the rock properties for each rock type by computing a covariance matrix, and estimating class proportions given a set of memberships, where the class proportions are the ratios of the number of members in a particular class to the total number of observations. The mean value may be determined across all data points attributed to a particular rock type for each depth-independent physical property, such as natural radioactivity and photoelectric factor, for example.

When executed by processor 112, update class membership module 134 may be configured to compare parameters for the subsurface formation determined based on at least one rock physics model and its corresponding covariance matrix selected by model fitting module 133 with measured parameters received from measurement data 155, to update class memberships for each data point. For each depth, different rock physics models may produce different parameter predictions, or different depth trends. While many rock physics models can be made to fit the data, poor fits of models to data will result in the parameters and/or depth trends being geologically implausible, or poorly constrained. Update class membership module 134 may therefore be configured to analyse the models and penalise poor fits and non-physical results, to find better class membership fits.

Processor 112 executing update class membership module 134 may perform classification based on the current estimated parameters in the rock physics models, taking into account depth trends and assessing the fit of the measurement data to the models. The classification may comprise update class membership module 134 using the best fitting rock physics model as identified by model fitting module 133 with the parameters computed by model fitting module 133 to update the rock type memberships. According to some embodiments, this updating may be achieved by estimating the memberships as probabilities of each data point at a given depth belonging to a given rock type, where a rock physics model suitable for that rock type provides the best fit to the data. This may be done by performing a Bayesian classification of the data points for each rock type, for example. According to some embodiments, class memberships may be updated by randomly selecting from a set of candidate models that fit the data equally well and may reward or punish rock physics model based on their properties such as the number of parameters. According to some embodiments, model fitting module 133 and update class membership module 134 may alternatively or additionally use a machine learning algorithm to assess the goodness of fit. According to some embodiments, model fitting module 133 and update class membership module 134 may be configured to be robust against outliers in the processed data, to tolerate noise, and to handle multiple clusters that contain both small and large numbers of data points.

When executed by processor 112, convergence check module 135 may be configured to determine whether the probability of the ensemble of the data points belonging to each of the rock types for the rock physics model that has been fit to it is higher or lower than the probability was prior to the updating of the rock type memberships as performed by update class membership module 134. If the comparison indicates convergence has been achieved based on a convergence criterion being met, then the most recently identified rock physics model may be passed to output module 136. An example convergence criterion may be when the change of the total likelihood between iterations is below a certain threshold, for example. The likelihood of a model is a measure of how well the model predictions reproduce the measurement data. The total likelihood is a combination of the likelihoods of each of the rock physics models for the identified classes. A further example of a convergence criterion may be when a threshold number of iterations have been performed.

If convergence has not been achieved, convergence check module 135 may pass the class memberships from the last iteration back to model fitting module 133, to allow model fitting module 133 to re-fit rock physics models to the data with memberships determined at the latest iteration to achieve a better fit.

When executed by processor 112, output module 136 may be configured to receive the most recently fit set of rock physics models from update class membership module 134, and to output the data to a user via user I/O 114 or to an external computing device via communications module 116. The set of instances of fitted rock physics models passed from the convergence check module 135 provide a set of probable rock types together with a set of parameters for each of the fitted models. The output data may provide a quantification of probable rock types, fluids, minerals, and mechanical properties of the rock types in the subsurface, along with their uncertainties.

For each depth for which measurement data 155 were provided, there is a distribution of probabilities of membership of each fitted rock physics model, and a set of parameters for those rock physics models. Associated with each fitted rock physics model there is a covariance matrix that represents the uncertainty in rock physics model parameters in the final fit. For each fitted rock physics model there is a second covariance matrix that describes the statistical dispersion of residuals. According to some embodiments, the covariance matrix may be replaced by a shape or structure matrix that affects the shape of the distribution in a different way compared to mere shifting or scaling it. According to some embodiments, the output data comprises the rock types identified in the well, and the set of rock physics models for each rock type at each depth. The data may further comprise the uncertainty of each rock physics model being appropriate for each data point, and the parameters and trends of the rock physics models expected at the depths of the measured locations in the subsurface formation, and in nearby locations if such parameters and trends can be predicted based on the rock physics models. The output data may also contain the model acoustic impedances for each data point at each depth.

According to some embodiments, the output data may be used as input into a quantitative geophysical analysis, such as the inversion of seismic survey data, to identify the spatial distribution of different kinds of rocks, minerals and fluid contents in the subsurface formations of the survey area, as well as the uncertainty of the identified position. This data may be used to inform future drilling operations, to improve recovery of fluids or gases discovered in the subsurface, to better manage the resources of the subsurface formation, and for other purposes.

According to some embodiments, the output data may include depth trends and predictive covariance matrices for each rock physics model, which can be used directly for stochastic simulations and in seismic inversions, and for other quantitative analyses of seismic data.

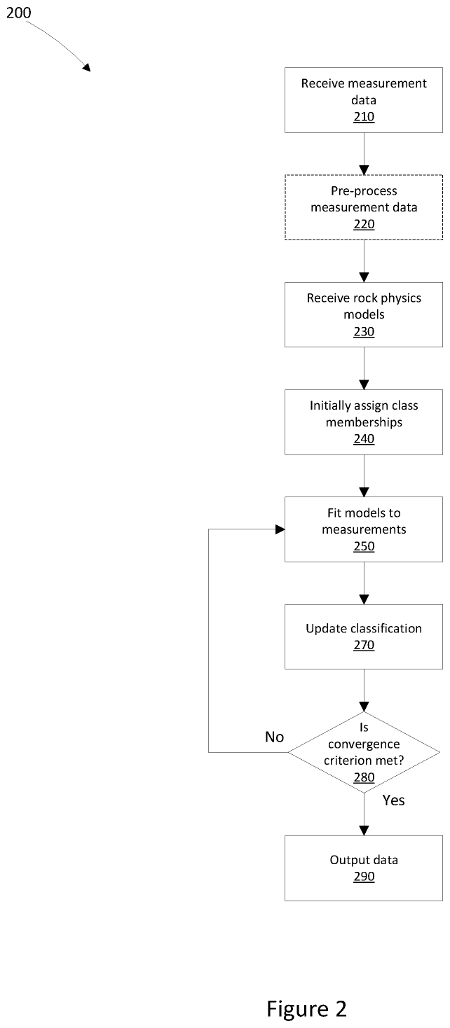

FIG. 2 shows a flowchart illustrating a method 200 performed by processor 112 of computing device 110 executing program code 130. At step 210, processor 112 receives measurement data 155 from remote device 150 via communications module 116. At optional step 220, processor 112 executes optional pre-processing module 131 to apply pre-processing to measurement data 155.

At step 230, processor 112 receives rock physics models from rock physics model library 145 via communications module 116. At step 240, processor executes initialisation module 132 to perform an initial clustering of the data points of measurement data 155, and to initially assign class memberships to the data points of the received data.

At step 250, processor 112 executes model fitting module 133 to fit the clustered data points to the rock physics model retrieved at step 230. Processor 112 may do this by fitting each of the retrieved rock physics models to each class of rock selected or determined for the data set. For each class, processor 112 may determine the rock physics model that produces the smallest residuals. Residuals may be determined by processor 112 to be the absolute difference between the measured data point values and the values predicted by the rock physics model for each data point. During the model fitting process performed by processor 112 executing model fitting module 133, processor 112 is configured to minimise the loss function or equivalently, maximise the likelihood function. A penalty may be used to control how this fit is implemented. For example, fitting may implemented by minimising the sum of the squares of residuals in some embodiments, or by any other suitable loss function. Processor 112 may further estimate the class proportion for the entire dataset. Each rock physics model that has been fit to a rock class may be referred to as a fitted rock physics model, being an instance of the rock physics model with determined parameters that explains the variability in the measured data with respect to the properties of the rock, such as depth, degree of cementation or temperature.

At step 270, processor 112 executes update class membership module 134 to compare estimated parameters based on the rock physics model to measured parameters retrieved from measurement data 155 and update the class memberships for the data. Processor 112 updates the class membership probabilities, being the probability for each data point that it belongs in the assigned class.

At step 280, processor 112 executes convergence check module 135 to determine whether a convergence criterion has been met. If the criterion has been met, at step 290 processor 112 executes output module 136 to output the rock type, rock physics model, and/or other parameters determined based on measurement data 155. The output may comprise a subset of fitted rock physics models that best explain the measured data. The output may further comprise a model for the residuals in the measured data for each fitted rock physics model.

If, however, the convergence criterion has not been met, then processor 112 returns to step 250 of method 200, to again execute model fitting module 133, to re-fit the data to the models in an attempt to achieve a better fit.

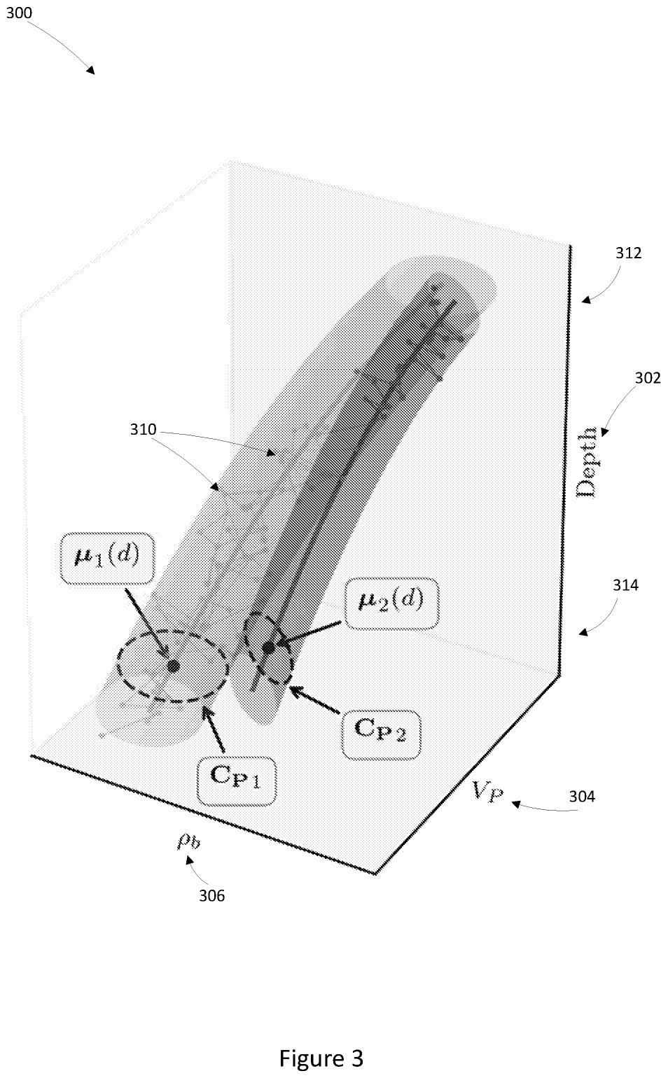

FIG. 3 shows a graph 300 illustrating a data set 310 for two different rock types within a formation analysed by method 200 that are to be identified as distinct data clusters. Specifically, graph 300 shows the trends of the data set 310, being changes in VP 304 and bulk density ρ_{b} 306, with changes in depth 302. Models μ₁(d) and μ₂(d) are example rock physics models that have been fit to the data set 310 by method 200. Ellipses C_{P1} and C_{P2} show the levels of uncertainty for the two rock physics models, and these ellipses may be parameterized by the associated data covariance matrices.

As seen from graph 300, models μ₁(d) and μ₂(d) overlap at a shallow depth 312, but the differences between the models increase at a greater depth 314, with each model following a different compaction trend. The two models μ₁(d) and μ₂(d) are used by method 200 in an attempt to fit data set 310 at each depth point. The models should also reproduce any observed trends in the measured properties of the subsurface formation with an increase in depth. In the illustrated embodiment, only model μ₁(d) fits data set 310 at greater depth 314, while model μ₂(d) is a better fit to data set 310 at shallow depth 312. The depth trends for each model are ideally physically based, accounting for compaction and cementation. However, in some embodiments models may be found as an empirical fit to data points. This may occur where a physically based model cannot be found or to avoid overfitting a data set with too many parameters, for example.

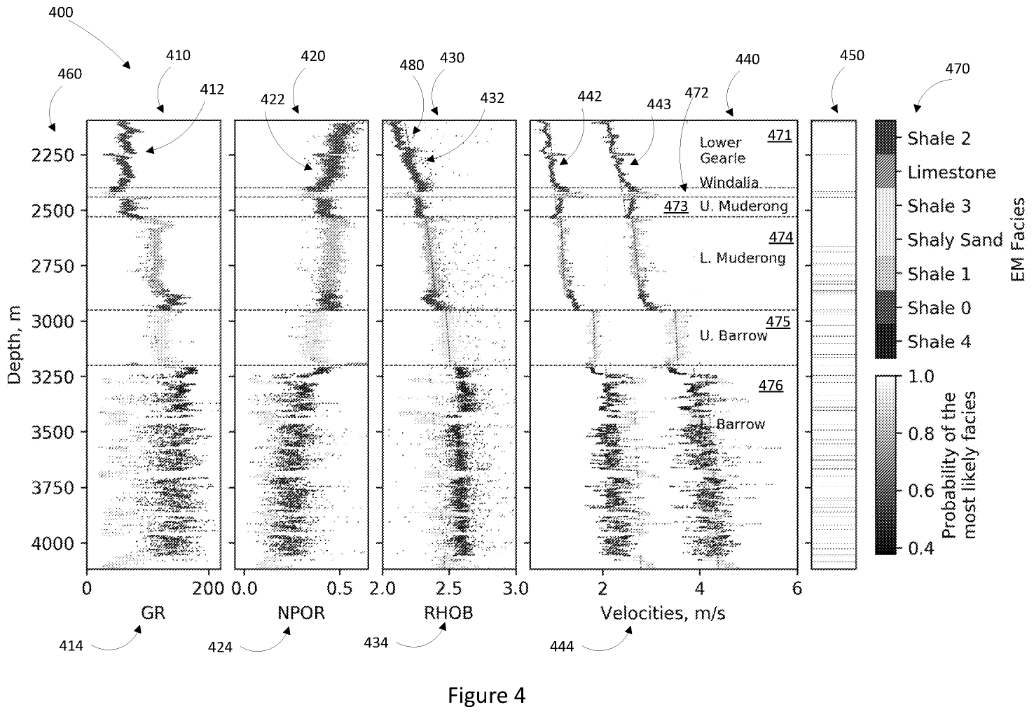

FIG. 4 shows five graphs 410, 420, 430, 440 and 450 showing data sets fit to rock physics models using method 200. Specifically, graph 410 shows data set 412 mapped against depth axis 460 and gamma ray axis 414, graph 420 shows data set 422 mapped against depth axis 460 and neutron porosity axis 424, graph 430 shows data set 432 mapped against depth axis 460 and bulk density axis 434, and graph 450 shows data sets 442 and 443 mapped against depth axis 460 and velocity axis 444, where data set 442 corresponds to V_{S} and data set 443 corresponds to V_{P}. Each graph is split by depth to indicate the data points that have been assigned to different rock physics models as shown by key 470. Specifically, data points in slice 471 of the graphs correspond to a shale rock physics model, data points in slice 472 of the graphs correspond to a limestone rock physics model, data points in slice 473 of the graphs correspond to the shale rock physics model at a different depth, data points in slice 474 of the graphs correspond to a shaly sand rock physics model, and data points in slices 475 and 476 of the graphs correspond to further shale rock physics models. Graph 450 shows the certainties for each data point along depth axis 460 corresponding to the designated rock physics model as shown in key 470.

Lines 480 show trends, which are smooth but not continuous with depth as the rock type changes. In other words, the trends are smooth for each rock type but can change abruptly with depth when the rock type changes. The trends fitted to rock physics models can be extended to depths beyond those where measurements have been made and data sets exist. This allows for physical properties of rocks to be predicted at depths and locations beyond those of any drilled boreholes. The parameters used to fit the models, such as the gamma ray data, neutron porosity data, bulk density, V_{S} and V_{P} data in the illustrated embodiment, tell us more about the likely minerals, porosity and fluids present at each depth.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method for modelling a subsurface formation, the method comprising:
receiving measurement data related to the subsurface formation, the measurement data comprising a plurality of data points;
determining at least one rock physics model, each rock physics model relating to a rock type;
assigning each data point of the measurement data to at least one initial rock class membership;
fitting each determined rock physics model of the at least one rock physics model to the data points of the measurement data to produce at least one fitted rock physics model;
reassigning each data point to at least one rock class based on the fitted rock physics models;
determining whether a convergence criterion has been met; and
responsive to the convergence criterion not being met, repeating the fitting and reassigning steps.

2. The method of claim 1, further comprising:
based on the convergence criterion being met, outputting at least one fitted one rock physics model that models at least a portion of the subsurface formation; and
determining at least one property of the subsurface formation based on the at least one output rock physics model.

3. (canceled)

4. The method of claim 2, further comprising performing an operation on the subsurface formation based on the output data.

5. The method of claim 1, further comprising pre-processing the measurement data to improve the quality of the measurement data
wherein improving the quality of the measurement data comprises at least one of:
identifying and discarding invalid measurement data, or
receiving information from tool indicators within the subsurface formation and correcting the measurement data according to the information received.

6-7. (canceled)

8. The method of claim 1, wherein assigning each data point of the measurement data to at least one initial rock class membership comprises randomly assigning each data point of the measurement data to at least one initial rock class membership.

9. The method of claim 1, wherein assigning each data point of the measurement data to at least one initial rock class membership comprises using an automatic clustering method.

10. The method of claim 1, wherein fitting each determined rock physics model to the data points comprises performing parameter estimation for each rock type and weighing each rock type by the rock class memberships.

11. The method of claim 1, wherein fitting each determined rock physics model to the data points comprises identifying a best fitting rock physics model for each data point using an optimisation algorithm.

12. The method of claim 1, wherein reassigning each data point to at least one rock class based on the fitted rock physics models comprises comparing at least one parameter for the subsurface formation determined by each fitted rock physics model with at least one measured parameter determined from the received measurement data.

13. The method of claim 1, wherein reassigning each data point to at least one rock class based on the fitted rock physics models comprises assessing a goodness of fit between each fitted rock physics model and each data point.

14. The method of claim 1, wherein fitting each determined rock physics model to the data points of the measurement data comprises jointly minimising the misfits for more than one set of physical properties of the subsurface formation.

15. The method of claim 1, wherein fitting each determined rock physics model to the data points of the measurement data comprises severally minimising the misfits for more than one set of physical properties of the subsurface formation.

16. The method of claim 1, wherein the more than one set of physical properties include at least one of the elastic properties of the subsurface formation, the electrical properties of the subsurface formation and the electromagnetic properties of the subsurface formation.

17. (canceled)

18. The method of claim 1, wherein determining at least one rock physics model comprises receiving the at least one rock physics model from a remote database.

19. The method of claim 1, wherein determining whether a convergence criterion has been met comprises determining whether a threshold number of iterations of the method have been performed

20. The method of claim 1, wherein determining whether a convergence criterion has been met comprises determining whether a change in a likelihood that the data points belong to the fitted rock physics models is below a predetermined threshold.

21. The method of claim 1, further comprising rejecting rock physics models that do not fit the physical bounds of the measurement data.

22. The method of claim 1, wherein each rock physics model defines a relationship between at least one physical rock property and a rock burial depth for a particular rock type.

23. The method of claim 1, wherein the measurement data is received from at least one of a wellbore and a core or cutting of the subsurface formation.

24. (canceled)

25. A system for modelling a subsurface formation, the system comprising:
memory storing program code; and
a processor configured to access the program code;
wherein, when executing the program code, the processor is caused to:
receive measurement data related to the subsurface formation, the measurement data comprising a plurality of data points;
receive at least one rock physics model;
assign each data point of the measurement data to at least one initial rock class membership;
fit each received rock physics model to the data points;
reassign each data point to at least one rock class based on the fitted rock physics models;
determine whether a convergence criterion has been met; and
responsive to the convergence criterion not being met, repeating the fitting and reassigning steps.
